(19) United States
(12) Patent Application Publication
(10) Pub. No.: US 2011/0234726 A1
(43) Pub. Date: Sep. 29, 2011

(54) INK JET RECORDING METHOD

(75) Inventors: Hiroshi Mukai, Shiojiri-shi (JP); Katsuko Aoki, Nagano-ken (JP)

(73) Assignee: SEIKO EPSON CORPORATION

(21) Appl. No.: 13/071,725

(22) Filed: Mar. 25, 2011

(30) Foreign Application Priority Data
Mar. 26, 2010 (JP) 2010-072436

(51) Int. Cl. B41J 2/01

(52) U.S. Cl. 347/102

(57) ABSTRACT

An ink jet recording method includes recording with an aqueous ink composition on a non-ink-absorbing or low-ink-absorbing recording medium. The aqueous ink composition contains a water-insoluble colorant, water-insoluble thermoplastic resin particles, a surfactant, a first solvent including at least one selected from 2-pyrrolidone and N,N′-dimethylpropylene urea, a second solvent including 1,2-hexanediol, and a third solvent including at least one selected from glycol diethers having a boiling point of 240° C. or more and 280° C. or less.

### BACKGROUND

1. Technical Field

The present invention relates to an ink jet recording-type printing method.

2. Related Art

An ink jet recording method is a recording method for printing by ejecting ink droplets from fine nozzles, which are formed in an ink jet head, and allowing the ink droplets to fly and adhere to recording media. The ink jet recording method has been used for printing mainly on water-absorbing surfaces such as paper. However, the ink jet recording method is characterized by being capable of printing high-quality images with high resolution at a high speed using a relatively low-cost apparatus, and thus techniques for printing on non-water-absorbing recording media using the ink jet recording method has recently been proposed.

For example, nonaqueous inks each including an organic solvent as a main component have been frequently used for the ink jet recording method for non-absorbing recording media which do not absorb ink or low-absorbing recording media. The nonaqueous inks are excellent in that the inks have a quick-drying property and water resistance, and blurring of images can be prevented. However, the nonaqueous inks have the problem of the odors and harmfulness of the solvents during drying because images are formed by evaporation of the solvents on surfaces of the recording media. Further, in view of concern about the influences of the organic solvents on the environment, an ink jet recording method having higher safety and little influence on the environment has been investigated for non-ink-absorbing or low-ink-absorbing recording media.

For example, Japanese Unexamined Patent Application Publication No. 2007-291257 discloses a nonaqueous ink jet ink including an organic solvent with relatively high safety and thus having no problem of order and having excellent printability, ejection stability, and safety for polyvinyl chloride (PVC), which is a material of non-absorbing recording media, and also discloses an ink jet recording method using the ink jet ink. However, the ink contains 80% by mass or more of diethylene glycol diethyl ether as an example of a main solvent and thus obviously has very low safety as compared with aqueous inks. Further, a large amount of solvent evaporated has a significant influence on the environment.

For example, Japanese Unexamined Patent Application Publication No. 2008-260820 discloses a water-based heat-fixing ink jet ink capable of forming good high-speed-print image quality without causing spots on polyvinyl chloride recording media and capable of being used stably for a long time, and also discloses a heat-fixing ink jet recording method using the ink. The amount of the organic solvent added is 10 to 35% by mass, and diethylene glycol diethyl ether is used as an example of the organic solvent. It is also described that the occurrence of spots is suppressed by combining a specified organic solvent and a water-soluble resin, thereby achieving good recording image quality. However, in this patent document, only recording image quality of printing on polyvinyl chloride recording media is described, and lower abrasion resistance of an aqueous ink than that of a nonaqueous ink is not sufficiently examined by printing on non-absorbing recording media.

### SUMMARY

An advantage of some aspects of the invention is that the invention provides an ink jet recording method capable of forming images with a quick-drying property, high image quality without ink blurring, and excellent abrasion resistance on recording media having non-absorbing or low-absorbing recording surfaces.

The present invention has been achieved for solving at least part of the above-mentioned problems and can be realized as embodiments or application examples below.

### APPLICATION EXAMPLE 1

An ink jet recording method according to an embodiment of the present invention includes a first step of heating a non-ink-absorbing or low-ink-absorbing recording medium to a temperature range of 50° C. or more and 80° C. or less and ejecting droplets of an aqueous ink composition using an ink jet recording apparatus; and a second step of heating the recording medium to a temperature range of 60° C. or more and 90° C. or less to dry he aqueous ink composition ejected on the recording medium. The aqueous ink composition contains water, at least one water-insoluble colorant, water-insoluble thermoplastic resin particles, a surfactant, a first solvent including at least one selected from 2-pyrrolidone and N,N′-dimethylpropylene urea, a second solvent including 1,2-hexanediol, and a third solvent including at least one selected from glycol diethers having a boiling point of 240° C. or more and 280° C. or less. The content (W1) of the first solvent in the aqueous ink composition is 4% to 14% by mass, the content (W2) of the second solvent in the aqueous ink composition is 3% to 8% by mass, and the content (W3) of the third solvent in the aqueous ink composition is 4% to 10% by mass. The total (W1+W2+W3) of the contents of the first, second, and third solvents is 22% by mass or less. By the ink jet recording method of Application Example 1, it is possible to decrease blurring of an image formed on a non-ink-absorbing recording medium and form a recorded matter with excellent abrasion resistance.

### APPLICATION EXAMPLE 2

In the ink jet recording method described in the above-described application example, a glycol diether as the third solvent is tetraethylene glycol dimethyl ether.

### APPLICATION EXAMPLE 3

In the ink jet recording method described in the above-described application example, the water-insoluble colorant is a pigment and is dispersed in the aqueous ink composition using a water-soluble resin.

### APPLICATION EXAMPLE 4

In the ink jet recording method described in the above-described application example, the water-insoluble thermoplastic resin particles are particles of an acrylic resin or a styrene-acrylic acid copolymer resin.

### APPLICATION EXAMPLE 5

In the ink jet recording method described in the above-described application example, the surfactant is a silicon-based surfactant.

### APPLICATION EXAMPLE 6

In the ink jet recording method described in the above-described application example, the recording medium is heated with a heater or hot air.

### DESCRIPTION OF EXEMPLARY EMBODIMENTS

A preferred embodiment of the present invention described below. In the embodiment, an example of the present invention is described. The present invention is not limited to the embodiment and includes various modification examples to be carried out within a scope where the gist of the invention is not changed.

### 1. INK JET RECORDING METHOD

An ink jet recording method according to an embodiment of the present invention include's a first step of heating a non-ink-absorbing or low-ink-absorbing recording medium to a temperature range of 50° C. or more and 80° C. or less and ejecting droplets of an aqueous ink composition with an ink jet recording apparatus; and a second step of heating the recording medium to a temperature range of 60° C. or more and 90° C. or less to dry the aqueous ink composition ejected on the recording medium. The aqueous ink composition contains water, at least one water-insoluble colorant, water-insoluble thermoplastic resin particles, a surfactant, a first solvent including at least one selected from 2-pyrrolidone and N,N′-dimethylpropylene urea, a second solvent including 1,2-hexanediol, and a third solvent including at least one selected from glycol diethers having a boiling point of 240° C. or more and 280° C. or less. The content (W1) of the first solvent in the aqueous ink composition is 4% to 14% by mass, the content (W2) of the second solvent in the aqueous ink composition is 3% to 8% by mass, and the content (W3) of the third solvent in the aqueous ink composition is 4% to 10% by mass. The total (W1+W2+W3) of the contents of the first, second, and third solvents is 22% by mass or less. In the present invention, “image” represents a print pattern formed by a dot group and includes a text print and a solid print.

### 1.1. Ink Jet Recording Process

An ink jet recording method according to an embodiment of the present invention includes a first step of heating a non-ink-absorbing or low-ink-absorbing recording medium to a temperature range of 50° C. or more and 80° C. or less and ejecting droplets of an aqueous ink composition; and a second step of heating the recording medium to a temperature range of 60° C. or more and 90° C. or less to dry the aqueous ink composition ejected on the recording medium.

An ink jet recording apparatus is not particularly limited as long as recording can be performed by ejecting ink droplets and adhering the droplets to a recording medium. However, the ink jet recording apparatus is preferably provided with a function of heating the recording medium during printing. Here, “during printing” represents a time required from the transfer of the recording medium to a paper guide portion of the ink jet recording apparatus to the transfer of the recording medium to an ink drying mechanism after the ink droplets are ejected and adhered to the recording medium by the ink jet recording apparatus.

Examples of the function of heating the recording medium include a print heater function of heating the recording medium by bringing a heat source into direct contact with the recording medium, a dryer function of irradiating infrared light or microwaves (electromagnetic waves with a maximum wavelength of about 2,450 MHz) or blowing hot air, and the like without direct contact with the recording medium. The print heater function and the dryer function can be used independently or used simultaneously. Consequently, the heating temperature can be controlled during printing.

After the ink droplets are ejected and adhered to the recording medium by the ink jet recording apparatus, the recording medium may be dried with a dryer or a constant-temperature oven set to a predetermined temperature.

The recording method of the present invention is suitable for printing on non-ink-absorbing or low-ink-absorbing recording media.

Examples of the non-ink-absorbing recording media include recording media each including a substrate, such as a plastic film or paper, coated with plastic, and recording media each including a substrate and a plastic film bonded thereon. As the plastic film, a film of polyvinyl chloride, polyethylene terephthalate, polystyrene, polyurethane, polyethylene, polypropylene, or the like can be used. Examples of the low-ink-absorbing recording media include print paper such as art paper, coated paper, matte paper, and the like.

In the specification, “non-ink-absorbing or low-ink-absorbing recording media” represents recording media exhibiting an amount of water absorption of 10 mL/m² or less within 30 msec^{1/2} from a start of contact in the Bristow method. The Bristow method is a method most popularized as a method for measuring an amount of liquid absorbed within a short time and is used in Japan Technical Association of the Pulp and Paper Industry (JAPAN TAPPI). The details of the test method are described in “Liquid Absorbency Test Method of Paper and Paperboard-Bristow Method” of standard No. 51 of “JAPAN TAPPI paper pulp test method, 2000”.

As the non-ink-absorbing or low-ink-absorbing recording media, a variety of products are commercially available for application to outdoor exhibits required to have long-term weatherability and prints required to have strength of recording media. A recording medium can be appropriately selected from these recording media according to application.

The ink jet recording method using the ink jet recording apparatus can be performed, for example, as described below. First, an aqueous ink composition (described below) is ejected as droplets on a recording medium heated to a temperature range of 50° C. or more and 80° C. or less with a print heater provided in the ink jet recording apparatus. As the ink jet ejection method, any conventional known method can be used, and particularly, a method of ejecting droplets by using vibrations of piezoelectric elements (recording method using an ink jet head which forms ink droplets by mechanical deformation of electrostrictive elements) can record excellent images.

Next, the aqueous ink composition ejected on the recording medium is dried by heating the recording medium, on which an ink jet image is formed, to the temperature range of 60° C. or more and 90° C. or less using a dryer provided in the ink jet recording apparatus or a constant-temperature oven connected to the ink jet recording apparatus.

In the first step of forming an image by heating the non-ink-absorbing or low-ink-absorbing recording medium to a temperature range of 50° C. or more and 80° C. or less and ejecting the aqueous ink composition as droplets, a high-quality image with little density unevenness and little blurring can be formed on the non-ink-absorbing or low-ink-absorbing recording medium.

Then, in the second step of heating the recording medium, on which the ink jet image is formed, to a temperature range of 60° C. or more and 90° C. or less, water etc. contained in the aqueous ink composition ejected to the recording medium are rapidly evaporated and scattered, thereby forming a film of resin particles (described below) contained in the aqueous ink composition. As a result, a dried ink is strongly bonded to the recording medium by forming the film of the resin particles on the recording medium, and thus a high-quality image with little density unevenness and little blurring can be formed within a short time.

In this case, the heating temperature of the recording medium can be appropriately controlled to the temperature range of 50° C. or more and 80° C. or less in the first step and to the temperature range of 60° C. or more and 90° C. or less in the second step according to the heat resistance of the recording medium.

When the heating temperature is controlled to 60° C. or more in the second step, evaporation and scattering of a liquid medium contained in the aqueous ink composition can be promoted. However, in the second step, a higher heating temperature is advantageous for any one of rapid drying, abrasion resistance, and decrease in image blurring. However, when the heating temperature of the recording medium exceeds 90° C., some type of the recording medium may be deformed, or a problem such as contraction of a recorded image may occur when the recording medium is heated and cooled. Also, there occur the undesirable problems of increasing the power assumption of the heater used for heating, increasing the exhaust heat from an ink jet printer due to the heating mechanism, and the like. In view of these problems, the upper limit of the heating temperature of the recording medium is preferably 90° C.

In addition, when a polyvinyl chloride recording medium which is easily deformed at high temperature is used, the heating temperatures in both the first and second steps are preferably 60° C. or less. When the heating temperature in the first step exceeds 60° C., a recording medium composed of polyvinyl chloride may be rapidly softened and easily deformed, thereby causing difficulty in transferring the recording medium by the ink jet recording apparatus. Since polyvinyl chloride has the function of being permeated with, swollen with, or dissolved in a first solvent and third solvent described below, which are contained in the aqueous ink composition, the aqueous ink composition can be dried even at the heating temperature of 60° C. or less in the second step. However, when the heating temperature in the second step is 50° C. or less, the solvent in the aqueous ink composition may remain, and thus a film of the thermoplastic resin particles cannot be satisfactorily formed, thereby failing to achieve strength of a recorded image.

The heat drying time of the recording medium is not particularly limited as long as the liquid medium present in the aqueous ink composition can be evaporated and scattered, and the film of the thermoplastic resin particles can be formed. The heat-drying time can be appropriately determined in consideration of the solvent, resin particles, and printing speed used.

### 1.2. Aqueous Ink Composition

An aqueous ink composition used in an ink jet recording method according to an embodiment of the present invention is described in detail below.

### 1.2.1. Solvent

The aqueous ink composition used in the ink jet recording method according to the embodiment contains a first solvent including at least one selected from 2-pyrrolidone and N,N′-dimethylpropylene urea, a second solvent including 1,2-hexanediol, and a third solvent including at least one selected from glycol diethers having a boiling point of 240° C. or more and 280° C. or less.

The first solvent including at least one selected from 2-pyrrolidone and N,N′-dimethylpropylene urea functions as a good dissolving agent or softening agent for thermoplastic resin particles described below and polyvinyl chloride which is a material of non-absorbing recording media.

The first solvent has a boiling point of 240° C. to 250° C. and the concentration thereof in an ink residue on the recording medium is increased by concentration in the heating step, thereby dissolving part of the thermoplastic resin particles. The dissolved thermoplastic resin particles impart the effect of accelerating the formation of a film of a solidified ink, which contains a colorant as a main component, and strongly adhering the film on the non-ink-absorbing or low-ink-absorbing recording medium.

When vinyl chloride is used for the non-ink-absorbing recording medium, part of the first solvent contained in the aqueous ink composition permeates in the recording medium, swells the recording medium, or dissolves the recording medium, thereby causing the function of further enhancing adhesion between the solidified ink and polyvinyl chloride and improving the drying property of the ink.

The content (W1) of the first solvent is 4% by mass or more and 14% by mass or less based on the total mass of the aqueous ink composition. The content (W1) of the first solvent is more preferably 4% by mass or more and 7% by mass or less based on the total mass of the aqueous ink composition. When the content (W1) of the first solvent is 4% by mass or more, an image can be strongly fixed to the recording medium, while when the content (W1) of the first solvent is 7% by mass or less, the drying property of an image can be further improved. On the other hand, when the content (W1) of the first solvent is less than 4% by mass, the film formation by the thermoplastic resin particles in the aqueous ink composition may be decreased, thereby causing insufficient solidification/fixing of the image. In addition, when the content (W1) of the first solvent exceeds 14% by mass, part of the first solvent remaining on the surface of the recording medium is not easily evaporated and scattered, thereby causing insufficient drying of the image.

The second solvent including 1,2-hexanediol is a low-surface-tension solvent having the function to, by interaction with the surfactant, further enhance wettability of the recording medium with the aqueous ink composition and uniformly wet the recording medium with the ink. The low-surface-tension solvent refers to a solvent having a surface tension of 40 mN/m or less at room temperature. By uniformly wetting the recording medium with the ink, ink density unevenness and blurring on the recording medium can be decreased.

1,2-Hexanediol is a 1,2-alkanediol having a boiling point of 223° C. and 6 carbon atoms and has a boiling point slightly lower than those of the first solvent and glycol diether described below. Therefore, this solvent remains in the ink up to immediately before the final stage of drying after evaporation of water and thus has the function to uniformly wet, with the ink, the recording medium having a recording surface composed of non-absorbing plastic, thereby causing the excellent effect of decreasing blurring in a formed image. On the other hand, a 1,2-alkanediol having 5 or less carbon atoms has a lower boiling point than that of 1,2-hexanediol and thus does not remain up to the final stage of drying, thereby causing the poor function of continuously uniformly wetting the recording medium until the ink is solidified. In addition, a 1,2-alkanediol having 4 or less carbon atoms may exhibit low ink wettability for the recording medium having a recording surface composed of non-absorbing plastic, thereby causing ink density unevenness and blurring. Further, a 1,2-alkanediol having 7 or more carbon atoms has low water solubility, and thus, in some cases, the solvent cannot be added in an amount necessary for securing wettability or, the storage stability of the ink composition may be inhibited.

The content (W2) of the second solvent is 3% by mass or more and 8% by mass or less based on the total mass of the aqueous ink composition. The content (W2) of the second solvent is more preferably 5% by mass or more and 7% by mass or less based on the total mass of the aqueous ink composition. When the content (W2) of the second solvent is 5% by mass or more, a high-quality image with less blurring can be formed, while when the content (W2) of the second solvent is 7% by mass or less, the drying property of an image tends to be further improved. On the other hand, when the content (W2) of the second solvent is less than 3% by mass, ink wettability of the non-ink-absorbing or low-ink-absorbing recording medium may be degraded, thereby failing to form a good image. In addition, when the content (W2) of the second solvent exceeds 8% by mass, the solvent is not easily evaporated and scattered, thereby causing insufficient drying of an image.

As the third solvent including at least one selected from glycol diethers having a boiling point in the range of 240° C. to 280° C., a solvent having a slightly higher boiling point than those of the first and second solvents is selected and added to the aqueous ink composition for ink jet recoding, so that the third solvent has the effect of preventing clogging and ejection failure and improving printing stability by suppressing drying solidification of the ink on a nozzle surface of an ink jet head due to evaporation of the solvent.

In addition, like the first solvent, the third solvent has the function to slowly dissolve or swell the thermoplastic resin particles contained in the ink composition. During the time from adhesion of the ink to the recording medium to vaporization of the solvents, the thermoplastic resin particles dissolved or swollen with the first and third solvents have the effect of strongly fixing the recording medium and a solidified substance containing as a main component the colorant which is a nonvolatile component in the ink composition.

Further, like the first solvent, the third solvent has the property of dissolving or swelling polyvinyl chloride which is a material of non-absorbing recording media. When polyvinyl chloride is used for the non-absorbing recording medium, the thermoplastic resin particles and polyvinyl chloride are more strongly fixed together by the action of the third solvent in combination with the first solvent, and the third solvent permeates or swells polyvinyl chloride. Therefore, the good rapid-drying property is exhibited even at a heating temperature of 60° C. considered as the upper limit temperature at which polyvinyl chloride can be heated.

A glycol diether having the property of dissolving the thermoplastic resin particles is determined by the following method.

First, 0.05 g of an emulsion containing the thermoplastic resin particles dispersed in water are added dropwise on a glass plate and allowed to stand at room temperature for one day to evaporate water. Then, the glass plate to which a solidified product of the thermoplastic resin particles adheres as a residue is immersed in a container containing a glycol diether, and the state of the solidified product is observed. If no change in the state is observed, the glycol diether can be determined to have no dissolving property, while if fogging, cracking, softening, swelling, or dissolving is observed, the glycol diether can be determined to have the property of dissolving the thermoplastic resin particles.

In addition, the polyvinyl chloride dissolving property of a glycol diether can be determined by the following method. A polyvinyl chloride sheet (Takiron plate, manufactured by Takiron Co., Ltd.) having a thickness of 1.0 mm is immersed in a glycol diether solvent and allowed to stand at room temperature for 1 hour. Then, the sheet is taken out from the solvent, washed with water, and dried, and conditions are observed. If no change in the conditions is observed, the glycol diether is determined to have no dissolving property, while if fogging, cracking, softening, swelling, or dissolving is observed in the sheet, a next adhesion test is further performed. First, 0.01 g of glycol diether is added dropwise on a strip-shaped recording medium with a recording surface facing upward, and another strip-shaped recording medium with a recording surface facing downward is superposed on a portion where the glycol diether is added. The two recording media are allowed to stand for 10 minutes with a load of 300 g applied to the recording medium superposed. Then, adhesiveness is examined by a tensile test with a load of 100 g applied in a direction described in the tensile shearing bonding strength test (JIS K6850). The solvent showing adhesiveness can be determined to have the property of dissolving polyvinyl chloride.

The glycol diether selected by the above determination method and having a boiling point in the range of 240° C. to 280° C. and the property of dissolving the thermoplastic resin particles and polyvinyl chloride is tetraethylene glycol dimethyl ether.

The content (W3) of the third solvent is 4% by mass or more and 10% by mass or less based on the total mass of the aqueous ink composition. The content (W3) of the third solvent is more preferably 5% by mass or more and 10% by mass or less based on the total mass of the aqueous ink composition.

When the content (W3) of the third solvent in the aqueous ink composition is 4% by mass or more, in the ink jet head which performs printing on the heated recording medium, clogging in nozzles due to solidification of the ink is effectively suppressed, thereby causing the function of improving printing stability. When the content (W3) of the third solvent in the aqueous ink composition is 5% by mass or more, printing stability is further improved.

When the content (W1) of the first solvent in the aqueous ink composition is 4% by mass or more, an image formed on the non-absorbing recording medium has good abrasion resistance at a third solvent content (W3) of 4% by mass or more. In addition, when the content (W1) of the first solvent in the aqueous ink composition is 6% by mass or more, the image formed on the non-absorbing recording medium has better abrasion resistance at a third solvent content (W3) of 5% by mass or more.

On the other hand, when the content (W3) of the third solvent in the aqueous ink composition exceeds 10% by mass, part of the third solvent remaining on the surface of the recording medium may be insufficiently evaporated and scattered, and thus the film formation by the resin component may be inhibited to degrade the abrasion resistance.

The total (W1+W2+W3) of the contents of the first, second, and third solvents is 22% by mass or less based on the total mass of the aqueous ink composition. When the total (W1+W2+W3) of the contents of the solvents exceeds 22% by mass, the solvents may remain without being sufficiently vaporized in the'heating step of drying the recording medium, thereby degrading the rapid drying property of the image.

### 1.2.2. Colorant

The aqueous ink composition used in the ink jet recording method according to the embodiment contains a water-insoluble colorant. As the water-insoluble colorant, a water-insoluble dye or pigment can be used, but a pigment is preferably used. A pigment not only is insoluble or slightly soluble in water but also has the property of being little discolored by light and gas. Therefore, a recorded matter obtained by printing with an ink composition containing a pigment has good water resistance, gas resistance, light resistance, and the like and good storage stability.

The aqueous ink composition can contain any pigment which is generally used for ink compositions for aqueous ink jet recording. As the pigment, for example, an organic pigment or inorganic pigment which is generally used in ink compositions for ink jet recording can be used.

As the inorganic pigment, titanium oxide, iron oxide, or carbon black produced by a known method such as a contact method, a furnace method, or a thermal method can be used.

As the organic pigment, an azo pigment (e.g., an azolake, an insoluble azo pigment, a condensed azo pigment, or a chelate azo pigment), a polycyclic pigment (e.g., a phthalocyanine pigment, a perylene pigment, a perinone pigment, an anthraquinone pigment, a quinacridone pigment, a dioxazine pigment, a thioindigo pigment, an isoindolinone pigment, or a quinophthalone pigment), a dye chelate (e.g., a basic dye chelate or an acid dye chelate), a nitro pigment, a nitroso pigment, or aniline black can be used. Among these pigments, a pigment with good affinity to water is preferably used.

More specifically, examples of a black ink pigment include carbon blacks (C. I. Pigment Black 7) such as furnace black, lamp black, acetylene black, channel black, the like; metals such as copper oxide, iron oxide (C. I. Pigment Black 11), titanium oxide, and the like; and organic pigments such as aniline black (C. I. Pigment Black 1), and the like.

Preferred specific examples of carbon black include carbon black manufactured by Mitsubishi Chemical Corporation, such as No. 2300, 900, MCF88, No. 20B, No. 33, No. 40, No. 45, No. 52, MA7, MA8, MA100, No. 2200B, and the like; carbon black manufactured by Degussa Corporation, such as Color Black FW1, FW2, FW2V, FW18, FW200, S150, S160, and S170, Printex 35, U, V, and 140U, and Special Black 6, 5, 4A, 4, and 250; carbon black manufactured by Columbia Carbon Inc., such as Conductex SC, and Raven 1255, 5750, 5250, 5000, 3500, 1255, and 700; and carbon black manufactured by Cabot Corporation, such as Regal 400R, 330R, and 660R, Mogul L, Monarch 700, 800, 880, 900, 1000, 1100, 1300, and 400, Elftex 12, and the like.

Examples of color ink pigments include C. I. Pigment Yellow 1 (fast yellow G), 3, 12 (disazo yellow AAA), 13, 14, 17, 23, 24, 34, 35, 37, 42 (yellow iron oxide), 53, 55, 74, 81, 83 (disazo yellow HR), 95, 97, 98, 100, 101, 104, 108, 109, 110, 117, 120, 138, 150, 151, 154, 155, 180, 185, and 213; C. I. Pigment Red 1, 2, 3, 5, 17, 22 (brilliant fast scarlet), 23, 31, 38, 48:2 (permanent red 2B (Ba)), 48:2 (permanent red 2B (Ca)), 48:3 (permanent red 2B (Sr)), 48:4 (permanent red 2B (Mn)), 49:1, 52:2, 53:1, 57:1 (brilliant carmine 6B), 60:1, 63:1, 63:2, 64:1, 81 (rhodamine 6G lake), 83, 88, 92, 101 (red iron oxide), 104, 105, 106, 108 (cadmium red), 112, 114, 122 (quinacridone magenta), 123, 146, 149, 166, 168, 170, 172, pigment violet 1 (rhodamine lake), 3, 5:1, 16, 19 (quinacridone red), 23, and 38; and C. I. Pigment Blue 1, 2, 15 (phthalocyanine blue R), 15:1, 15:2, 15:3 (phthalocyanine blue G), 15:4, 15:6 (phthalocyanine blue E), 16, 17:1, 56, 60, and 63; and the like.

The particle diameter of the pigment is not particularly limited, but is preferably 25 μm or less and more preferably 2 μm or less in terms of average particle diameter. By using a pigment with an average particle diameter of 25 μm or less, the occurrence of clogging can be suppressed, and more satisfactory ejection stability can be realized.

The content of the pigment is preferably 0.5% to 15% by mass and more preferably 1.0% to 10.0% by mass based on the whole ink composition.

The pigment can be stably easily dispersed and held in the aqueous ink composition by various methods. Examples of the methods include a method of dispersing with a water-soluble resin, a method of dispersing with a surfactant, and a method capable of dispersing and/or dissolving by chemically or physically introducing hydrophilic functional groups to the surfaces of pigment particles. Any one of these methods can be used for the aqueous ink composition used in the printing method according to the embodiment, and the methods can be used in combination according to demand. In particular, the method of dispersing the pigment in the aqueous ink composition with the water-soluble resin is preferred because when the aqueous ink composition adheres to the recording medium, adhesion between the recording medium and the ink composition and/or between the solid materials in the ink composition may be enhanced. In addition, the method of dispersing the pigment in the aqueous ink composition by chemically or physically introducing hydrophilic groups to the surfaces of pigment particles is preferred in view of enhancing the dispersion stability of the pigment and improving the storage stability of the aqueous ink composition.

Examples of the water-soluble resin which can be used for dispersing the pigment include polyvinyl alcohols, polyvinylpyrrolidones, polyacrylic acid, acrylic acid-acrylonitrile copolymers, vinyl acetate-acrylate copolymers, acrylic acid-acrylate copolymers, styrene-acrylic acid copolymers, styrene-methacrylic acid copolymers, styrene-methacrylic acid-acrylate copolymers, styrene-α-methylstyrene-acrylic acid copolymers, styrene-α-methylstyrene-acrylic acid-acrylate copolymers, styrene-maleic acid copolymers, styrene-maleic anhydride copolymers, vinylnaphthalene-acrylic acid copolymers, vinylnaphthalene-maleic acid copolymers, vinyl acetate-maleate copolymers, vinyl acetate-crotonic acid copolymers, vinyl acetate-acrylic acid copolymers, and the like; and salts thereof. Among these resins, particularly, a copolymer of a monomer having a hydrophobic functional group and a monomer having a hydrophilic functional group, and a polymer composed of a monomer having both a hydrophobic functional group and a hydrophilic functional group are preferred. As the form of a copolymer, any one of a random copolymer, a block copolymer, an alternating copolymer, and a graft copolymer can be used.

Examples of the salts include salts with basic compounds such as ammonia, ethylamine, diethylamine, triethylamine, propylamine, isopropylamine, dipropylamine, butylamine, isobutylamine, diethanolamine, triethanolamine, tri-iso-propanolamine, aminomethylpropanol, morpholine, and the like. The amount of the basic compound added is not particularly limited as long as it is the neutralization equivalent or more of the water-soluble resin.

The molecular weight of the water-soluble resin which can be used for dispersing the pigment is preferably in a range of 1,000 to 100,000 and more preferably in a range of 3,000 to 10,000 in terms of the weight-average molecular weight. With the molecular weight within the above range, stable dispersion of the colorant in water can be achieved, and in application to the aqueous ink composition, the viscosity, etc can be easily controlled. In addition, the acid value is preferably in a range of 50 to 300 and more preferably in a range of 70 to 150. With the acid value within this range, dispersibility of colorant particles in water can be stably secured, and a printed matter obtained by printing with the aqueous ink composition using the water-soluble resin has good water resistance.

As the water-soluble resin which can be used for dispersing the pigment, a commercial product can also be used. Specific examples of the commercial product include Joncryl 67 (weight-average molecular weight: 12,500, acid value: 213), Joncryl 678 (weight-average molecular weight: 8,500, acid value: 215), Joncryl 586 (weight-average molecular weight: 4,600, acid value: 108), Joncryl 611 (weight-average molecular weight: 8,100, acid value: 53), Joncryl 680 (weight-average molecular weight: 4,900, acid value: 215), Joncryl 682 (weight-average molecular weight: 1,700, acid value: 238), Joncryl 683 (weight-average molecular weight: 8,000, acid value: 160), and Joncryl 690 (weight-average molecular weight: 16,500, acid value: 240) (all being trade names, manufactured by BASF Japan Co., Ltd.).

Examples of the surfactant used for dispersing the pigment include anionic surfactants such as alkanesulfonic acid salts, α-olefinsulfonic acid salts, alkylbenzenesulfonic acid salts, alkylnaphthalenesulfonic acid salts, acylmethyl taurine acid salts, dialkylsulfosuccinic acid salts, alkylsulfuric acid ester salts, sulfonated olefins, polyoxyethylene alkyl ether sulfuric acid ester salts, alkylphosphoric acid ester salts, polyoxyethylene alkyl ether phosphoric acid ester salts, monoglyceride phosphoric acid ester salts, and the like; amphoteric surfactants, such as alkylpyridinium salts, alkyl amino acid salts, alkyldimethyl betaines, and the like; and nonionic surfactants, such as polyoxyethylene alkyl ethers, polyoxyethylene alkyl phenyl ethers, polyoxyethylene alkyl esters, polyoxyethylene alkyl amides, glycerin alkyl esters, sorbitan alkyl esters, and the like.

The adding amount of the water-soluble resin or surfactant which can be used for dispersing the pigment is preferably 1% to 100% by mass and more preferably 5% to 50% by mass based on 1% by mass of the pigment. Within this range, dispersion stability of the pigment in water can be secured.

An example of the method for allowing the pigment particles to disperse and/or dissolve by chemically or physically introducing hydrophilic functional groups to the surfaces of the pigment particles is a method of introducing, to the pigment, —ON, —COOM, —CO—, —SO₃M, —SO₂NH₂, —RSO₂M, —PC₃HM, —PO₃M₂, —SO₂NHCOR, —NH₃, or —NR₃ (wherein M represents a hydrogen atom, an alkali metal, ammonium, or organic ammonium, and R represents an alkyl group having 1 to 12 carbon atoms, a phenyl group which may be substituted, or a naphthyl group which may be substituted) as a hydrophilic functional group. Such a functional group is physically and/or chemically introduced to the surfaces of the pigment particles by grafting directly and/or through another group. Examples of a polyvalent group include an alkylene group having 1 to 12 carbon atoms, a phenylene group which may be substituted, a naphthylene group which may be substituted, and the like.

As the surface treatment method, the surfaces of the pigment particles are treated with a sulfur-containing treating agent so that —SO₃M and/or —RSO₂M (M represents a counter ion, such as a hydrogen ion, an alkali metal ion, an ammonium ion, or an organic ammonium ion) is chemically bonded to the particle surfaces. That is, more preferably, the pigment is dispersed in a solvent which has no active proton and no reactivity with sulfonic acid and in which the pigment is insoluble or slightly soluble. Then, the surfaces of the particles are treated with amidosulfuric acid or a complex of sulfur trioxide and tertiary amine so that —SO₃M and/or —RSO₂M is chemically bonded to the particle surfaces, thereby allowing the pigment to disperse and/or dissolve in water.

As the surface treatment method for grafting the functional group or a salt thereof to the surfaces of the pigment particles directly or through a polyvalent group, various known surface treatment methods can be used. Examples thereof include a method of treating commercial oxidized carbon black with ozone or a sodium hypochlorite solution and further oxidizing the carbon black to further hydrophilize the surfaces (for example, Japanese Unexamined Patent Application Publication Nos. 7-258578, 8-3498, 10-120958, 10-195331, and 10-237349), a method of treating carbon black with 3-amino-N-alkyl-substituted pyridium bromide (for example, Japanese Unexamined Patent Application Publication Nos. 10-195360 and 10-330665), a method of dispersing an organic pigment in a solvent in which the organic pigment is insoluble or slightly soluble, and introducing sulfone groups to the surfaces of the pigment particles with a sulfonating agent (for example, Japanese Unexamined Patent Application Publication Nos. 8-283596, 10-110110, and 10-110111), and a method of dispersing an organic pigment in a basic solvent which forms a complex with sulfur trioxide and introducing a sulfone group or a sulfonamino group by surface-treating the organic pigment with sulfur trioxide added (Japanese Unexamined Patent Application Publication No. 10-110114). The method for forming the surface-treated pigment used in the present invention is not limited to these methods.

The type of the functional group grafted to one pigment particle may be single or multiple. The type of the functional group grafted and the degree of grafting may be appropriately determined in consideration of dispersion stability in ink, a color density, the drying property on the front surface of an ink jet head, etc.

As the method for dispersing the pigment in water, the pigment, water, and the water-soluble resin as a resin dispersant, the pigment, water, and the surfactant, or the surface-treated pigment and water, and if required, a water-soluble organic solvent, a neutralizer; etc. are added, and the resultant mixture is dispersed with a generally used disperser such as a ball mill, a sand mill, an attritor, a roll mill, an agitator mill, a Henschel mixer, a colloid mill, an ultrasonic homogenizer, a jet mill, an angmill, or the like. In this case, as described above, the pigment is dispersed until the particle diameter of the pigment is preferably 25 μm or less and more preferably 2 μm or less in terms of the average particle diameter in view of securing dispersion stability of the pigment in water.

### 1.2.3. Thermoplastic Resin Particles

The aqueous ink composition used in the ink jet recording method according to the embodiment contains water-insoluble thermoplastic resin particles. The thermoplastic resin particles have the function to solidify the ink and strongly fix the solidified ink to the recording medium in the step of drying the aqueous ink composition ejected on the recording medium by heating the recording medium to the temperature range of 60° C. or more and 90° C. or less. The recoded matter recorded with the aqueous ink composition containing the resin particles has excellent abrasion resistance due to this function on the non-ink-absorbing recording medium.

The thermoplastic resin particles may be added so as to be completely dissolved in the aqueous ink composition or added as dispersed particles, i.e., in an emulsion state or a suspension state. The aqueous ink composition used in the ink jet recording method according to the embodiment preferably contains the resin particles in an emulsion state or a suspension state. When the resin particles are added in an emulsion state or a suspension state, the viscosity of the aqueous ink composition can be easily adjusted in a proper range for the ink jet recording method according to the embodiment, thereby easily securing storage stability and ejection stability.

Examples of a component of the thermoplastic resin particles include homopolymers or copolymers of acrylic acid, acrylates, methacrylic acid, methacrylates, acrylonitrile, cyanoacrylates, acrylamide, olefins, styrene, vinyl acetate, vinyl chloride, vinyl alcohol, vinyl ether, vinyl pyrrolidone, vinyl pyridine, vinyl carbazole, vinyl imidazole, and vinylidene chloride; fluorocarbon resins; natural resins, and the like. A copolymer can be used in any one of the forms of a random copolymer, a block copolymer, an alternating copolymer, and a graft copolymer. The thermoplastic resin particles are preferably particles of an acrylic resin or a styrene-acrylic acid copolymer resin.

As the thermoplastic resin particles, those obtained using a known material and method can be used. For example, those described in Japanese Examined Patent Application Publication No. 62-1426 and Japanese Unexamined Patent Application Publication Nos. 3-56573, 3-79678, 3-160068, and 4-18462 may be used. Also, commercial products may be used. Examples thereof. Microgel E-1002 and Microgel E-5002 (trade name, manufactured by Nippon Paint Co., Ltd.), Boncoat 4001 and Boncoat 5454 (trade names, manufactured by Dainippon Ink & Chemicals, Inc.), SAE1014 (trade name, manufactured by Nippon Zeon Co., Ltd.), Saibinol SK-200 (trade name, manufactured by Saiden Chemical Industry Co., Ltd.), Joncryl 7100, Joncryl 390, Joncryl 711, Joncryl 511, Joncryl 7001, Joncryl 632, Joncryl 741, Joncryl 450, Joncryl 840, Joncryl 74J, Joncryl HRC-1645J, Joncryl 734, Joncryl 852, Joncryl 7600, Joncryl 775, Joncryl 537J, Joncryl 1535, Joncryl PDX-7630A, Joncryl 352J, Joncryl 352D, Joncryl PDX-7145, Joncryl 538J, Joncryl 7640, Joncryl 7641, Joncryl 631, Joncryl 790, Joncryl 780, and Joncryl 7610 (trade name, manufactured by BASF Japan Inc.).

### 1.2.4. Surfactant

The aqueous ink composition used in the ink jet recording method according to the embodiment contains the surfactant. The surfactant has the function to uniformly spread the ink on the recording medium without causing density unevenness and blurring.

As the surfactant, a silicon-based surfactant is preferably used. As the silicon-based surfactant, a polysiloxane compound or the like is preferably used, and examples thereof include polyether-modified organosiloxanes and the like. Also, a commercial product can be used, and examples thereof include BYK-306, BYK-307, BYK-333, BYK-341, BYK-345, BYK-346, and BYK-348 (trade name, manufactured by BYK Chemie Japan, Inc.), KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017 (trade names, all manufactured by Shin-Etsu Chemical Co., Ltd.).

### 1.2.5. Water

The aqueous ink composition used in the ink jet recording method according to the embodiment contains water. The water is a main medium in the aqueous ink composition and is a component to be evaporated and scattered in the above-described heating step.

The water is preferably pure water or ultrapure water, such as ion exchanged water, ultrafiltered water, Milli-Q water, distilled water, or the like, from which ionic impurities are removed as much as possible. In addition, use of water sterilized by ultraviolet irradiation or addition of hydrogen peroxide is preferred because the occurrence of fungi or bacteria can be prevented when the pigment dispersion solution and the aqueous ink composition using the pigment dispersion solution are stored over a long time.

### 1.2.6. Other Components

The aqueous ink composition used in the ink jet recording method according to the embodiment can further contain a pH adjuster, a preservative/fungicide, an anticorrosive agent, a chelating agent, etc.

Examples of the pH adjuster include potassium dihydrogen phosphate, disodium hydrogen phosphate, sodium hydroxide, lithium hydroxide, potassium hydroxide, ammonia, diethanolamine, triethanolamine, triisopropanolamine, potassium carbonate, sodium carbonate, sodium hydrogen carbonate, and the like.

Examples of the preservative/fungicide include sodium benzoate, sodium pentachlorophenol, sodium 2-pyridinethiol-1-oxide, sodium sorbate, sodium dehydroacetate, 1,2-dibenzisothiazolin-3-one, and the like. Examples of commercial products include Proxel XL2 and Proxel GXL (trade name, manufactured by Avecia), Denicide CSA and NS-500 W (trade name, manufactured by Nagase Chemtex Corporation), and the like.

Examples of the anticorrosive agent include benzotriazole and the like.

Examples of the chelating agent include ethylenediamine tetraacetic acid and salts thereof (disodium dihydrogen ethylenediamine tetraacetate and the like), and the like.

### 1.2.7. Physical Properties

The viscosity at 20° C. of the aqueous ink composition used in the ink jet recording method according to the embodiment is preferably 2 mPa·s or more and 10 mPa·s or less and more preferably 3 mPa·s or more and 8 mPa·s or less. When the viscosity at 20° C. of the aqueous ink composition is in this range, a proper amount of droplets of the aqueous ink composition can be ejected from nozzles, and flying bend and scattering of the droplets can be further decreased, thereby permitting desirable use for the ink jet recording apparatus. The viscosity of the aqueous ink composition can be measured by maintaining the aqueous ink composition at a temperature of 20° C. using vibrating viscometer VM-100AL (manufactured by Yamaichi Electronic Co.,).

### 2. EXAMPLES

Although the present invention is described in further detail below with reference to examples, the present invention is not limited to these examples.

### 2.1. Preparation of Aqueous Ink Composition

### 2.2.1. Preparation of Pigment Dispersion Solution

An aqueous ink composition used in the examples contained a water-insoluble pigment as a colorant. When the pigment was added to the aqueous ink composition, the pigment was previously dispersed with a water-soluble resin.

The pigment dispersion solution was prepared as follows. First, 3.0 parts by mass of a styrene-acrylic acid copolymer (weight-average molecular weight: 25,000, acid value: 180) as the water-insoluble resin was added to and dissolved in 84.4 parts by mass of ion exchange water in which 0.6 part by mass of a 30% aqueous ammonia solution (neutralizing agent) was dissolved. Then, 12 parts by mass of each of pigments below was added to the resultant solution, followed by dispersion with zirconia beads for 10 hours. Then, impurities such as coarse particles and dust were removed by centrifugation with a centrifugal separator so that the pigment content was 12% by mass. The types of the pigments used for producing pigment dispersion solutions are given below.

C. I. Pigment Black 7 (used for a black pigment dispersion solution)

C. I. Pigment Yellow 74 (used for a yellow pigment dispersion solution)

C. I. Pigment Red 122 (used for a magenta pigment dispersion solution)

C. I. Pigment Blue 15:3 (used for a cyan pigment dispersion solution)

### 2.2. Preparation of Aqueous Ink Composition and Ink Set

Aqueous ink compositions of the four colors of black, yellow, magenta, and cyan were prepared for an ink set by using the pigment dispersion solutions prepared in the above “2.1.1. Preparation of pigment dispersion solution” and material compositions shown in Tables 1 and 2, thereby producing ink set Examples 1 to 12 and Comparative examples 1 to 7 having different compositions. Each of the aqueous ink compositions was prepared by placing the pigment dispersion solution and the materials shown in Tables 1 and 2 in a container, stirring and mixing the resultant mixture with a magnetic stirrer for 1 hour, and then removing impurities such as coarse particles and dust by filtration with a membrane filter having a pore size of 5 μm. In Tables 1 and 2, all numerical values shown are % by mass, and ion exchange water was adjusted so that the total of each aqueous ink composition was 100% by mass.

TABLE 1

| | | Example 1 | Example 2 | Example 3 | Example 4 | Example 5 | Example 6 | Example 7 |
|---|---|---|---|---|---|---|---|---|
| Colorant | Pigment solid | 4.0 | 4.0 | 4.0 | 4.0 | 4.0 | 4.0 | 4.0 |
| | content | | | | | | | |
| Pigment | Water-soluble | 1.0 | 1.0 | 1.0 | 1.0 | 1.0 | 1.0 | 1.0 |
| dispersant | resin styrene- | | | | | | | |
| | acrylic acid | | | | | | | |
| | copolymer solid | | | | | | | |
| | content | | | | | | | |
| Thermoplastic | Styrene-acrylic | 3.0 | 3.0 | 3.0 | 3.0 | 3.0 | 3.0 | 3.0 |
| resin particles | acid copolymer | | | | | | | |
| | solid content | | | | | | | |
| First solvent | 2-Pyrrolidone | 4.0 | 6.0 | 5.0 | 7.0 | 4.0 | 4.0 | 4.0 |
| | N,N′-dimethyl | | | | | | | |
| | propylene urea | | | | | | | |
| Second | 1,2-Hexane diol | 5.0 | 5.0 | 6.0 | 6.0 | 3.0 | 3.0 | 8.0 |
| solvent | | | | | | | | |
| Third solvent | Tetraethylene | 10.0 | 8.0 | 6.0 | 5.0 | 4.0 | 10.0 | 4.0 |
| | glycol dimethyl | | | | | | | |
| | ether | | | | | | | |
| Surfactant | Silicon surfactant | 0.5 | 0.5 | 0.5 | 0.5 | 0.5 | 0.5 | 0.5 |

| Water | Balance to total 100 | | | | | | |
|---|---|---|---|---|---|---|---|
| Quick-drying property | Good | Good | Good | Good | Good | Good | Fair |
| Abrasion resistance | Good | Good | Good | Good | Fair | Good | Fair |
| Image quality | Good | Good | Good | Good | Fair | Fair | Good |

| | | | | Example | Example | Example |
|---|---|---|---|---|---|---|
| | | Example 8 | Example 9 | 10 | 11 | 12 |
| Colorant | Pigment solid content | 4.0 | 4.0 | 4.0 | 4.0 | 4.0 |
| Pigment dispersant | Water-soluble resin | 1.0 | 1.0 | 1.0 | 1.0 | 1.0 |
| | styrene-acrylic acid | | | | | |
| | copolymer solid | | | | | |
| | content | | | | | |
| Thermoplastic resin | Styrene-acrylic acid | 3.0 | 3.0 | 3.0 | 3.0 | 3.0 |
| particles | copolymer solid | | | | | |
| | content | | | | | |
| First solvent | 2-Pyrrolidone | 4.0 | 9.0 | 9.0 | 14.0 | |
| | N,N′-dimethyl | | | | | 7.0 |
| | propylene urea | | | | | |
| Second solvent | 1,2-Hexane diol | 8.0 | 3.0 | 8.0 | 3.0 | 6.0 |
| Third solvent | Tetraethylene glycol | 10.0 | 10.0 | 4.0 | 4.0 | 5.0 |
| | dimethyl ether | | | | | |
| Surfactant | Silicon surfactant | 0.5 | 0.5 | 0.5 | 0.5 | 0.5 |

| Water | Balance to total 100 | | | | |
|---|---|---|---|---|---|
| Quick-drying property | Fair | Fair | Fair | Fair | Good |
| Abrasion resistance | Good | Good | Good | Good | Good |
| Image quality | Good | Fair | Good | Fair | Good |

TABLE 2

| | | Comparative | Comparative | Comparative | Comparative | Comparative | Comparative | Comparative |
|---|---|---|---|---|---|---|---|---|
| | | Example 1 | Example 2 | Example 3 | Example 4 | Example 5 | Example 6 | Example 7 |
| Colorant | Pigment solid | 4.0 | 4.0 | 4.0 | 4.0 | 4.0 | 4.0 | 4.0 |
| | content | | | | | | | |
| Pigment | Water-soluble | 1.0 | 1.0 | 1.0 | 1.0 | 1.0 | 1.0 | 1.0 |
| dispersant | resin styrene- | | | | | | | |
| | acrylic acid | | | | | | | |
| | copolymer solid | | | | | | | |
| | content | | | | | | | |
| Thermoplastic | Styrene-acrylic | 3.0 | 3.0 | 3.0 | 3.0 | 3.0 | 3.0 | 3.0 |
| resin particles | acid copolymer | | | | | | | |
| | solid content | | | | | | | |
| First solvent | 2-Pyrrolidone | 4.0 | 4.0 | 3.0 | 8.0 | 9.0 | 15.0 | 9.0 |
| | N,N′-dimethyl | | | | | | | |
| | propylene urea | | | | | | | |
| Second solvent | 1,2-Hexane diol | 3.0 | 2.0 | 8.0 | 3.0 | 9.0 | 3.0 | 6.0 |
| Third solvent | Tetraethylene | 3.0 | 10.0 | 4.0 | 11.0 | 4.0 | 4.0 | 8.0 |
| | glycol dimethyl | | | | | | | |
| | ether | | | | | | | |
| Surfactant | Silicon surfactant | 0.5 | 0.5 | 0.5 | 0.5 | 0.5 | 0.5 | 0.5 |

| Water | Balance to total 100 | | | | | | |
|---|---|---|---|---|---|---|---|
| Quick-drying property | Good | Good | Fair | Poor | Poor | Poor | Poor |
| Abrasion resistance | Poor | Good | Poor | Good | Good | Good | Good |
| Image quality | Fair | Poor | Good | Fair | Good | Fair | Good |

In Tables 1 and 2, the surfactant used was a silicon-based surfactant “BYK-348” (manufactured by BYK Chemie Japan, Inc.).

### 2.3. Evaluation Test

### 2.3.1. Evaluation of Quick-Drying Property

### (1) Formation of Recorded Matter

An ink jet printer PX-G930 (manufactured by Seiko Epson Corporation) was partially modified by mounting a temperature-variable heater on a paper guide portion so that a recording medium could be heated during image recording.

The ink jet printer was filled with the cyan ink of each of Examples 1 to 12 and Comparative Examples 1 to 7 prepared in 2.2., and a solid pattern was recorded on a polyethylene terephthalate film (trade name “Cold Lamination Film PG-50L”, manufactured by Lami Corporation, referred to as a “PET film” hereinafter) while the heater in the paper guide portion was adjusted so that the recording medium was 60° C. during recording. Immediately after recording, the recording medium was allowed to stand in a constant-temperature oven of 70° C. for 10 minutes to form a recorded matter for evaluation. The solid pattern image was formed with a longitudinal resolution of 720 dpi and a lateral resolution of 720 dpi so that an amount of ink printed was 1.0 mg/cm².

### (2) Evaluation of Recorded Matter

Immediately after each of the recorded matters was taken out from the constant-temperature oven after drying and returned to room temperature, a recorded portion of the recorded matter was touched directly with a finger, and the quick-drying property was evaluated according to criteria below. The evaluation results are shown as the quick-drying property in Tables 1 and 2.

Good: No ink adhesion to the finger was observed.

Fair: Although no ink adhesion to the finger was observed, stickiness remained on the surface of the recorded matter but was practically allowable.

Poor: Ink adhesion to the finger was observed.

### 2.3.2. Evaluation of Abrasion Resistance

### (1) Formation of Recorded Matter

The ink jet printer used in 2.3.1. was filled with the cyan ink of each of Examples 1 to 12 and Comparative Examples 1 to 7 prepared in “2.2.”, and a solid pattern was recorded on a PET film used as a recording medium, while the heater in the paper guide portion was adjusted so that the recording medium was 60° C. during recording. Immediately after recording, the recording medium was allowed to stand in a constant-temperature oven of 70° C. for 10 minutes to form a recorded matter for evaluation. The solid pattern image was formed with a longitudinal resolution of 720 dpi and a lateral resolution of 720 dpi so that an amount of ink printed was 1.0 mg/cm².

### (2) Evaluation Method for Recorded Matter

After the resultant recorded matter was maintained at 20° C. for 16 hours, the recorded matter and an abrader provided with a rubbing white cotton cloth were rubbed together using Gakushin-type rubbing fastness tester AB-301 (manufactured by Tester Sangyo Co., Ltd.) under the conditions of a load of 500 g and a number of times of rubbing of 10. The surface of the image was visually observed and evaluated according to the criteria below. The evaluation results are shown as the abrasion resistance in Tables 1 and 2.

Good: No scratch occurred even by 10 times of rubbing.

Fair: Although there was no scratch to expose a base, abrasion marks remained on the surface by 10 times of rubbing but were practically allowable.

Poor: There was a scratch to expose a base by 10 times of rubbing.

### 2.3.3. Evaluation of Image Quality

### (1) Formation of Recorded Matter

The ink jet printer used in 2.3.1. was filled with the four color inks of black, yellow, magenta, and cyan of the ink set of each of Examples 1 to 12 and Comparative Examples 1 to 7 prepared in 2.2., and a solid pattern having the colors in contact with each other was recorded on a PET film used as a recording medium, while the heater in the paper guide portion was adjusted so that the recording medium was 60° C. during recording. Immediately after recording, the recording medium was allowed to stand in a constant-temperature oven of 70° C. for 10 minutes to form a recorded matter for evaluation. The solid pattern image was formed with a longitudinal resolution of 720 dpi and a lateral resolution of 720 dpi so that an amount of ink printed was 1.2 mg/cm².

### (2) Evaluation Method for Recorded Matter

Blurring was observed in a contact portion between colors of the resultant recorded matter and evaluated according to the criteria below. The evaluation results are shown as image quality in Tables 1 and 2.

Good: No blurring occurred between colors.

Fair: Although slight bend occurred in a contact portion between colors, the bend had no practical problem because it was not blurring.

Poor: Blurring occurred between colors.

In the recorded matter formed using each of the aqueous ink compositions of Examples 1 to 12 shown in Table 1 and the PET film as the recording medium at a temperature of 60° C. in the first step and a temperature of 70° C. in the second step, the evaluation results of the quick-drying property confirm that the recorded matter has the good quick-drying property. In addition, the evaluation results of abrasion resistance indicate that the surfaces of images recorded on the PET films are little scratched and are excellent in abrasion resistance. Further, the evaluation results of image quality confirm that images formed on the PET films have no blurring or no bend which has a practical problem.

When the aqueous ink composition of Comparative Example 1 shown in Table 2 was used, a recorded matter with poor abrasion resistance was formed because the content (W3) of the third solvent in the aqueous ink composition of Comparative Example 1 was less than 4% by mass.

When the aqueous ink composition of Comparative Example 2 shown in Table 2 was used, a recorded matter with much blurring and poor image quality was formed because the content (W2) of the second solvent in the aqueous ink composition of Comparative Example 2 was less than 3% by mass.

When the aqueous ink composition of Comparative Example 3 shown in Table 2 was used, a recorded matter with poor abrasion resistance was formed because the content (W1) of the first solvent in the aqueous ink composition of Comparative Example 3 was less than 4% by mass.

When the aqueous ink composition of Comparative Example 4 shown in Table 2 was used, a recorded matter with poor quick-drying property was formed because the content (W3) of the third solvent in the aqueous ink composition of Comparative Example 4 exceeded 10% by mass.

When the aqueous ink composition of Comparative Example 5 shown in Table 2 was used, a recorded matter with poor quick-drying property was formed because the content (W2) of the second solvent in the aqueous ink composition of Comparative Example 5 exceeded 8% by mass.

When the aqueous ink composition of Comparative Example 6 shown in Table 2 was used, a recorded matter with poor quick-drying property was formed because the content (W1) of the first solvent in the aqueous ink composition of Comparative Example 6 exceeded 14% by mass.

When the aqueous ink composition of Comparative Example 7 shown in Table 2 was used, a recorded matter with poor quick-drying property was formed because the total content (W1+W2+W3) of the first, second, and third solvents in the aqueous ink composition of Comparative Example 7 exceeded 22% by mass.

### 2.3.4. Evaluation of Printing Stability

### (1) Formation of Recorded Matter

The ink jet printer used in 2.3.1. was filled with the four color inks of black, yellow, magenta, and cyan of the ink set of each of Examples 4 and 5 and Comparative Example 1 prepared in 2.2.

A mixed pattern including a text with an average duty of 10% and a figure was continuously printed for 1 hour on plain paper (Fuji Xerox P paper) used as a recording medium and heated to 60° C. Then, a recorded matter for evaluation was printed. The weight of ink ejected per dot was 20 ng, and a longitudinal resolution was 720 dpi and a lateral resolution of 720 dpi.

### (2) Evaluation Method for Recorded Matter

In the resultant recorded matter for evaluation, printing stability was evaluated by observing missing dots and bend. The term “bend” represents a deviation of an ink landing position on the recorded matter.

When the aqueous ink composition of Example 4 was used, missing dots or bend did not occur, and good printing stability was exhibited. When the aqueous ink composition of Example 5 was used, missing dots did not occur and bend occurred in a portion, but the printing stability was practically allowable. The use of the aqueous ink composition of Comparative Example 1 resulted in the occurrence of many missing dots and bends because the content (W3) of the third solvent in the aqueous ink composition of Comparative Example 1 was less than 4% by mass.

### 2.3.5. Evaluation of Heating Temperature

The same evaluation of the quick-drying property as in 2.3.1, the same evaluation of abrasion resistance as in 2.3.2, and the same evaluation of image quality as in 2.3.3 were performed except that the aqueous ink composition of Example 4 was used, the temperature of the heater in the paper guide portion was controlled to 80° C., the drying temperature immediately after recording was 90° C., and the drying time immediately after recording was 1 minute. The evaluation results are shown as the quick-drying property, abrasion resistance, and image quality of Example 13 in Table 3.

In Example 13 shown in Table 3 in which the aqueous ink composition of Example 4 was used, the temperature of the heater in the paper guide portion was controlled to 80° C., the drying temperature immediately after recording was 90° C., and the drying time immediately after recording was 1 minute, the evaluation results of the quick-drying property confirm that the recorded matter has the good quick-drying property. Also, the evaluation results of abrasion resistance show that the surface of the image recorded on the PET film is little scratched and excellent in abrasion resistance. The results of image quality confirm that the image recorded on the PET film has no blurring and good image quality.

The same evaluation of printing stability as in 2.3.4 was performed except that the aqueous ink composition of Example 4 was used and the temperature of the heater in the paper guide portion was controlled to 80° C. or 90° C.

When the temperature of the heater in the paper guide portion was controlled to 80° C., and the aqueous ink composition of Example 4 was used, the recorded matter obtained by continuous printing had no missing dot and partial bend, but printing stability was practically allowable. On the other hand, when the temperature of the heater in the paper guide portion was controlled to 90° C., and the aqueous ink composition of Example 4 was used, the recorded matter obtained by continuous printing showed the results of many missing dots and bends.

The same evaluation of the quick-drying property as in 2.3.1, the same evaluation of abrasion resistance as in 2.3.2, and the same evaluation of image quality as in 2.3.3 were performed except that the amount of ink printed for evaluating the quick-dry property was 0.8 mg/m², the aqueous ink compositions of Examples 3, 4, and 10 were used, a polyvinyl chloride film (trade name “LLSP EX113” manufactured by Sakurai Co., Ltd., referred to as a “PVC film” hereinafter) was used as a recording medium, the temperature of the heater in the paper guide portion was controlled to 50° C., the drying temperature immediately after recording was 60° C., and the drying time immediately after recording was 1 minute. The evaluation results are shown as the quick-drying property, abrasion resistance, and image quality of Examples 14 to 16 in Table 3.

In Examples 14 to 16 shown in Table 3, in which the aqueous ink compositions of Examples 3, 4, and 10 were used, a PVC film was used as a recording medium, the temperature of the heater in the paper guide portion was controlled to 50° C., the drying temperature immediately after recording was 60° C., and the drying time immediately after recording was 1 minute, the evaluation results of the quick-drying property show that any of the inks printed on the PVC films has the good quick-drying property. The evaluation results of abrasion resistance show that the images recorded on the PVC films are little scratched and are excellent in abrasion resistance. In addition, the evaluation results of image quality show that the images recorded on the PVC films have no blurring and excellent image quality.

The same evaluation of the quick-drying property as in 2.3.1, the same evaluation of abrasion resistance as in 2.3.2, and the same evaluation of image quality as in 2.3.3 were performed except that the amount of ink printed for evaluating the quick-dry property was 0.8 mg/m², the aqueous ink composition of Example 4 was used, a PVC film was used as a recording medium, the temperature of the heater in the paper guide portion was controlled to 40° C., the drying temperature immediately after recording was 50° C., and the drying time immediately after recording was 1 minute. The evaluation results are shown as the quick-drying property, abrasion resistance, and image quality of Comparative Example 8 in Table 3.

In Comparative Example 8 shown in Table 3, in which the aqueous ink composition of Example 4 was used, a PVC film was used as a recording medium, the temperature of the heater in the paper guide portion was controlled to 40° C., the drying temperature immediately after recording was 50° C., and the drying time immediately after recording was 1 minute, the evaluation results of the quick-drying property show excellent quick-drying property and practically allowable image quality, but a recorded matter with poor abrasion resistance was formed.

TABLE 3

| | | | | | Compar- |
|---|---|---|---|---|---|
| | Example | Example | Example | Example | ative |
| | 13 | 14 | 15 | 16 | Example 8 |
| Aqueous ink | Example 4 | Example 3 | Example 4 | Example | Example 4 |
| composition | | | | 10 | |
| Temperature | 80 | 50 | 50 | 50 | 40 |
| of first step | | | | | |
| (° C.) | | | | | |
| Temperature | 90 | 60 | 60 | 60 | 50 |
| of second | | | | | |
| step (> C.) | | | | | |
| Quick-drying | Good | Good | Good | Good | Good |
| property | | | | | |
| Abrasion | Good | Good | Good | Good | Poor |
| resistance | | | | | |
| Image | Good | Good | Good | Good | Fair |
| quality | | | | | |

The present invention is not limited to the above-described embodiment, and various modifications can be made. For example, the present invention includes substantially the same configuration (for example, a configuration with the same function, method, and results, or a configuration with the same objects and advantages) as in the above-described embodiment. Also, the present invention includes a configuration in which a nonessential portion of the configuration described in the embodiment is replaced. Further, the present invention includes a configuration exhibiting the same operation and advantages or being capable of achieving the same object as in the configuration described in the embodiment. Further, the present invention includes a configuration in which a known technique is added to the configuration described in the embodiment.

What is claimed is:

1. An ink jet recording method comprising:
heating a non-ink-absorbing or low-ink-absorbing recording medium to a temperature range of 50° C. or more and 80° C. or less and ejecting ink droplets of an aqueous ink composition on the recording medium with an ink jet recording apparatus; and
heating the recording medium to a temperature range of 60° C. or more and 90° C. or less to dry the aqueous ink composition ejected on the recording medium,
wherein the aqueous ink composition contains water, at least one water-insoluble colorant, water-insoluble thermoplastic resin particles, a surfactant, a first solvent including at least one selected from 2-pyrrolidone and N,N′-dimethylpropylene urea, a second solvent including 1,2-hexanediol, and a third solvent including at least one selected from glycol diethers having a boiling point of 240° C. or more and 280° C. or less;
the content (W1) of the first solvent in the aqueous ink composition is 4% to 14% by mass;
the content (W2) of the second solvent in the aqueous ink composition is 3% to 8% by mass;
the content (W3) of the third solvent in the aqueous ink composition is 4% to 10% by mass; and
the total (W1+W2+W3) of the contents of the first, second, and third solvents is 22% by mass or less.

2. The ink jet recording method according to claim 1, wherein a glycol diether as the third solvent is tetraethylene glycol dimethyl ether.

3. The ink jet recording method according to claim 1, wherein the water-insoluble colorant is a pigment and is dispersed in the aqueous ink composition with a water-soluble resin.

4. The ink jet recording method according to claim 1, wherein the water-insoluble thermoplastic resin particles are particles of an acrylic resin or a styrene-acrylic acid copolymer resin.

5. The ink jet recording method according to claim 1, wherein the surfactant is a silicon-based surfactant.

6. The ink jet recording method according to claim 1, wherein the recording medium is heated with a heater or hot air.
